(19) United States
(12) Patent Application Publication
(10) Pub. No.: US 2024/0275496 A1
(43) Pub. Date: Aug. 15, 2024

(54) LIGHT FEEDING APPARATUS AND LIGHT FEEDING METHOD

(71) Applicant: NIPPON TELEGRAPH AND TELEPHONE CORPORATION, Tokyo (JP)

(72) Inventors: Hiroaki KATSURAI, Musashino-shi, Tokyo (JP); Tomoaki YOSHIDA, Musashino-shi, Tokyo (JP)

(73) Assignee: NIPPON TELEGRAPH AND TELEPHONE CORPORATION, Tokyo (JP)

(21) Appl. No.: 18/569,573

(22) PCT Filed: Jul. 5, 2021
(86) PCT No.: PCT/JP2021/025270

§ 371 Date: Dec. 12, 2023

(51) Int. Cl. H04B 10/80

(52) U.S. Cl. CPC H04B 10/807

(57) ABSTRACT

An optical power feeding device including a photodiode array having a same number of photodiodes as a number of cores included in a multicore fiber, in which each of light receiving surfaces of the respective photodiodes faces a corresponding one of the cores of the multicore fiber, and at least the two photodiodes are connected in series to a power feeding target.

### TECHNICAL FIELD

The present invention relates to an optical power feeding device and an optical power feeding method.

### BACKGROUND ART

There is a technique called optical power feeding in which light passing through an optical fiber is converted into electricity by a photodiode and power feeding is performed. In the optical power feeding, there is a method of using a double-clad fiber, for example, in order to maximize the optical power feeding capability per fiber (see Non Patent Literature 1).

### CITATION LIST

### Non Patent Literature

Non Patent Literature 1: 150-W Power-Over-Fiber Using Double-Clad Fibers, M. Matsuura, Journal of Lightwave Technology (Volume: 38, Issue: 2, Jan. 15, 2020)

### SUMMARY OF INVENTION

### Technical Problem

However, in the invention described in Non Patent Literature 1, a plurality of transmitters, receivers, and optical power feeding circuits are used, and thus a system becomes complicated and expensive.

The present invention provides an optical power feeding device that can be implemented at lower cost.

### Solution to Problem

An aspect of the present invention is an optical power feeding device including a photodiode array having the same number of photodiodes as the number of cores included in a multicore fiber, in which each of light receiving surfaces of the respective photodiodes faces a corresponding one of the cores of the multicore fiber, and at least the two photodiodes are connected in series to a power feeding target.

### Advantageous Effects of Invention

The present invention provides an optical power feeding device that can be implemented at lower cost.

### BRIEF DESCRIPTION OF DRAWINGS

FIG. 1 is a view illustrating a configuration of an optical power feeding system 1.

FIG. 2 is an example of a multicore fiber 12 according to a first embodiment.

FIG. 3A is an example of a photodiode array 14 according to the first embodiment.

FIG. 3B is an example of the photodiode array 14 according to the first embodiment.

FIG. 4 is another example of the multicore fiber 12 according to the first embodiment.

FIG. 5 is another example of the photodiode array 14 according to the first embodiment.

FIG. 6 is an example of a multicore fiber 12 according to a second embodiment.

FIG. 7 is an example of a photodiode array 14 according to the second embodiment.

FIG. 8 is a flowchart illustrating operation of the optical power feeding system 1.

### DESCRIPTION OF EMBODIMENTS

Embodiments of the present invention will now be described in detail with reference to the drawings.

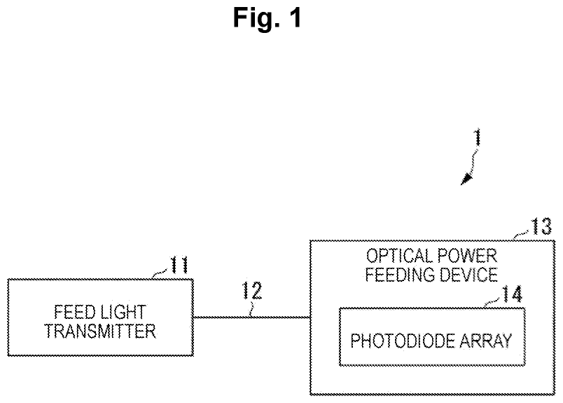

FIG. 1 is a view illustrating a configuration of an optical power feeding system 1. The optical power feeding system 1 includes a feed light transmitter 11, a multicore fiber 12, and an optical power feeding device 13.

The feed light transmitter 11 transmits feed light to the optical power feeding device 13 through the multicore fiber 12. The multicore fiber 12 is a fiber having a plurality of cores 120.

The optical power feeding device 13 converts feed light transmitted from the feed light transmitter 11 through the multicore fiber 12 into electric energy. The electric energy converted by the optical power feeding device 13 is supplied to the power feeding target via, for example, a DC/DC converter. The power feeding device is, for example, a charge/discharge circuit. The optical power feeding device 13 includes a photodiode array 14, and the photodiode array 14 includes a plurality of photodiodes 140. The number of photodiodes 140 included in the photodiode array 14 is the same as the number of cores 120 included in the multicore fiber 12. Each of the light receiving surfaces of the respective photodiodes 140 is arranged to face a corresponding one of the cores 120 of the multicore fiber 12.

In the first embodiment, the number of cores 120 and the number of photodiodes 140 are N×M (N is an integer of 2 or more, and M is an integer of 1 or more), the photodiodes 140 constitute M series circuits connected in series by N, and the M series circuits are connected in parallel to each other with respect to the power feeding target.

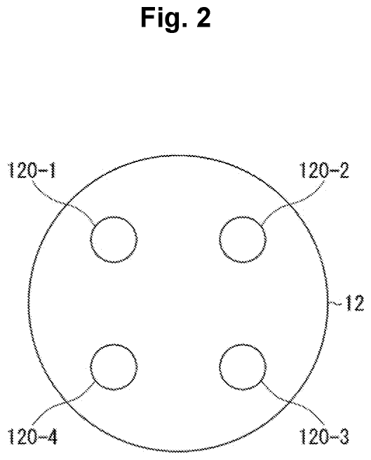

FIG. 2 is an example of the multicore fiber 12 in a case of N×M=4 in the first embodiment. The multicore fiber 12 illustrated in FIG. 2 has four cores 120-1 to 4.

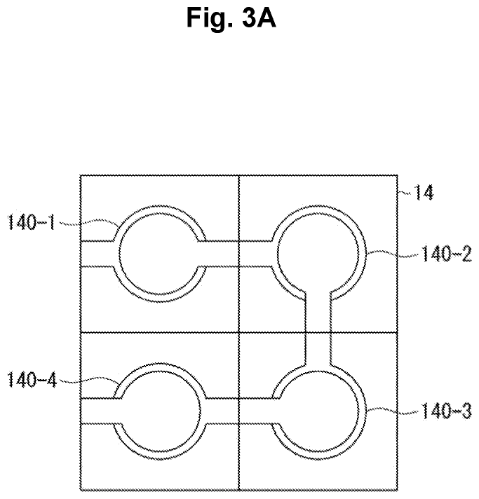

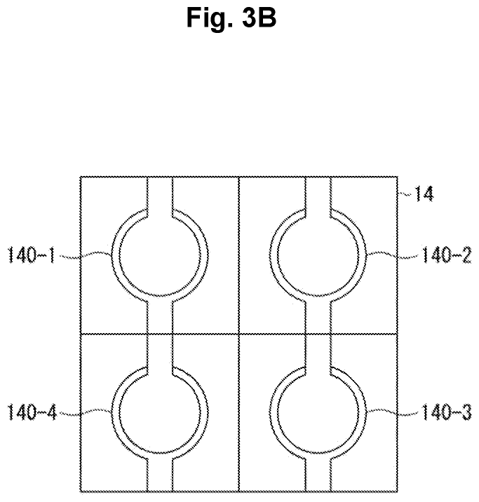

FIG. 3A is an example of the photodiode array 14 in a case of N=4 and M=1 in the first embodiment. FIG. 3B is an example of the photodiode array 14 in a case of N=M=2 in the first embodiment. The photodiode array 14 illustrated in each of FIG. 3A and FIG. 3B includes four photodiodes 140-1 to 4. The four photodiodes 140-1 to 4 correspond to the four cores 120-1 to 4 of the multicore fiber 12, respectively. For example, light transmitted through the core 120-1 is converted into electric energy by the photodiode 140-1.

In the photodiode array 14 illustrated in FIG. 3A, four photodiodes 140-1 to 4 are connected in series. In the photodiode array 14 illustrated in FIG. 3B, the two photodiodes 140-1 to 2 are connected in series, and the two photodiodes 140-3 to 4 are connected in series, so that two pieces of series circuits are configured. The two pieces of series circuits are connected in parallel to each other with respect to the power feeding target.

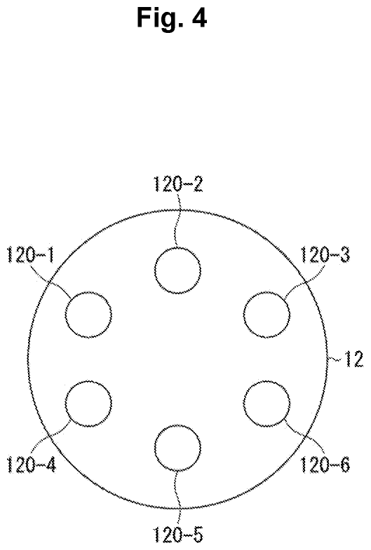

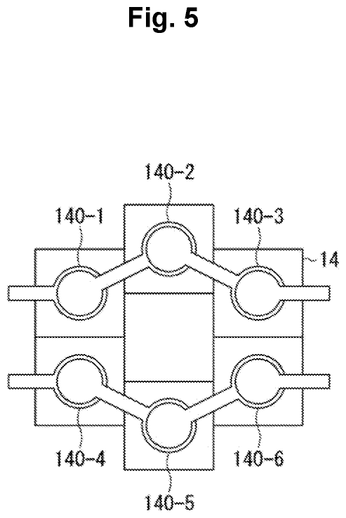

FIG. 4 is an example of the multicore fiber 12 in a case of N×M=6 in the first embodiment. The multicore fiber 12 illustrated in FIG. 4 has six cores 120-1 to 6. FIG. 5 is an example of the photodiode array 14 in a case of N=3 and M=2 in the first embodiment.

The photodiode array 14 illustrated in FIG. 5 includes six photodiodes 140-1 to 6. The six photodiodes 140-1 to 6 correspond to the six cores 120-1 to 6 of the multicore fiber 12, respectively. In the photodiode array 14 illustrated in FIG. 5, the three photodiodes 140-1 to 3 are connected in series, and the three photodiodes 140-4 to 6 are connected in series, so that two pieces of series circuits are configured. The two pieces of series circuits are connected in parallel to each other with respect to the power feeding target.

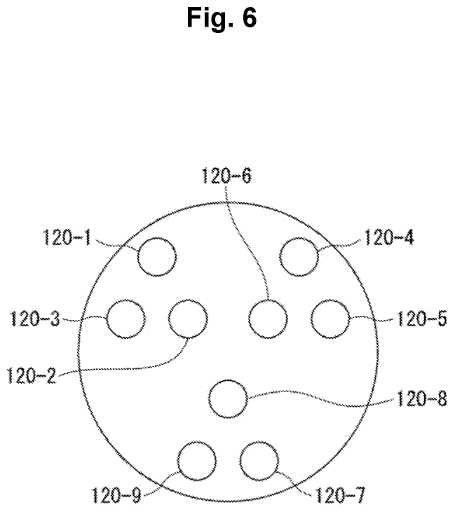

The centers of the plurality of cores 120 and the centers of the plurality of photodiodes 140 may be arranged to be vertices of a regular polygon. For example, in the multicore fiber 12 illustrated in FIG. 2 and the photodiode array 14 illustrated in FIG. 3A and FIG. 3B, the centers of the four cores 120-1 to 4 and the centers of the photodiodes 140-1 to 4 may be arranged to be vertices of a regular square. For example, in the multicore fiber 12 illustrated in FIG. 5 and the photodiode array 14 illustrated in FIG. 6, the centers of the six cores 120-1 to 6 and the centers of the photodiodes 140-1 to 6 may be arranged to be vertices of a regular hexagon.

In the first embodiment, since the photodiode array 14 includes the plurality of photodiodes 140 and the photodiodes 140 are connected in series, a transmitter and a receiver for optical power feeding can be integrated into one piece. As a result, the optical power feeding device can be implemented at low cost. Furthermore, the centers of the plurality of cores 120 and the centers of the plurality of photodiodes 140 are arranged to be vertices of a regular polygon. As a result, the cores 120 and the photodiodes 140 are arranged in point symmetry while a distance between the photodiodes 140 is decreased and loss due to resistance between the photodiodes is reduced, so that alignment can be facilitated.

### Second Embodiment

The cores 120 and the photodiodes 140 in the second embodiment constitute M series circuits connected in series by N, and the M series circuits are connected in parallel to each other with respect to the power feeding target, similarly to the first embodiment. At this time, each of the N×M photodiodes 140 is arranged to be a vertex of a regular polygon. In contrast, the number of cores 120 and photodiodes 140 in the second embodiment is N×M (N is an integer of 3 or more, and M is an integer of 3 or more.), and the cores 120 and the photodiodes 140 are arranged as follows. First, the centers of the N cores 120 and the centers of the N photodiodes 140 are arranged to be different vertices of regular N-sided polygons. Second, the centers of the regular N-sided polygons are arranged to be vertices of a regular M-sided polygon.

FIG. 6 is an example of a multicore fiber 12 according to the second embodiment. The multicore fiber 12 illustrated in FIG. 6 is a multicore fiber 12 in a case of N=3 and M=3. The three cores 120-1 to 3 are arranged such that the centers of the cores are the vertices of an equilateral triangle, and the cores 120-4 to 6 and the cores 120-7 to 9 are similarly arranged. Here, an equilateral triangle the vertices of which are the centers of the cores 120-1 to 3 is defined as an equilateral triangle T1, an equilateral triangle the vertices of which are the centers of the cores 120-4 to 6 is defined as an equilateral triangle T2, and an equilateral triangle the vertices of which are the centers of the cores 120-7 to 9 is defined as an equilateral triangle T3. The cores 120 are arranged such that the center of the equilateral triangle T1, the center of the equilateral triangle T2, and the center of the equilateral triangle T3 are vertices of an equilateral triangle.

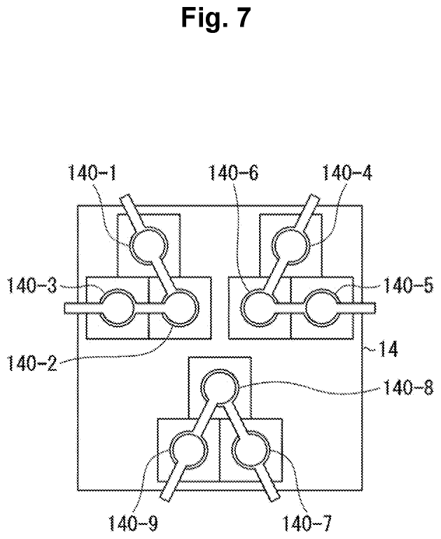

FIG. 7 is an example of a photodiode array 14 according to the second embodiment. The photodiodes 140 in the photodiode array 14 illustrated in FIG. 7 are arranged similarly to the cores 120 illustrated in FIG. 6. The photodiodes 140-1 to 3 are connected in series, and the photodiodes 140-4 to 6 and the photodiodes 140-7 to 9 are similarly connected in series. In addition, three pieces of series circuits connected in series are connected in parallel.

### <Modification>

A lens or a lens array may be provided between the multicore fiber 12 and the photodiode array 14 to adjust a core diameter of the core 120, a size of an opening of the photodiode 140, or a position irradiated with light transmitted through the core 120. Furthermore, at this time, positions where the cores 120 are arranged in the multicore fiber 12 and positions where the photodiodes 140 are arranged in the photodiode array 14 are in a similarity relation, and it is conceivable that light is adjusted by the lens or the lens array provided between the multicore fiber 12 and the photodiode array 14.

### CONCLUSION

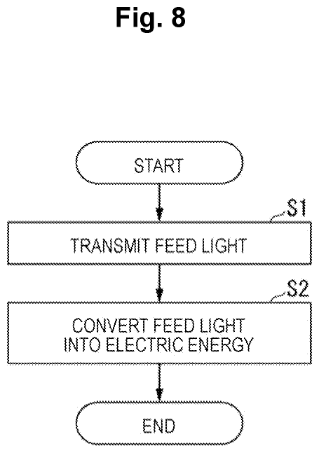

FIG. 8 is a flowchart illustrating operation of the optical power feeding system 1. The feed light transmitter 11 transmits feed light (step S1). The optical power feeding device 13 converts the feed light transmitted from the feed light transmitter 11 through the multicore fiber 12 into electric energy (step S2).

Although one embodiment of the present invention has been described in detail with reference to the drawings, specific configurations are not limited to the embodiment, and include design or the like within the scope not departing from the gist of the present invention.

### REFERENCE SIGNS LIST

1 Optical power feeding system
11 Feed light transmitter
12 Multicore fiber
120 Core
13 Optical power feeding device
14 Photodiode array
140 Photodiode

1. An optical power feeding device comprising
a photodiode array having a same number of photodiodes as a number of cores included in a multicore fiber, wherein
each of light receiving surfaces of the respective photodiodes faces a corresponding one of the cores of the multicore fiber, and
at least the two photodiodes are connected in series to a power feeding target.

2. The optical power feeding device according to claim 1, wherein
the number of cores and the number of photodiodes are N×M (N is an integer of 2 or more, and M is an integer of 1 or more),
the photodiodes constitute M series circuits connected in series by N, and the M series circuits are connected in parallel to each other with respect to the power feeding target.

3. The optical power feeding device according to claim 1, wherein
centers of the cores and centers of the photodiodes are arranged to be different vertices of a regular polygon.

4. The optical power feeding device according to claim 2, wherein
the centers of the N cores (N is an integer of 3 or more) and the centers of the N photodiodes are arranged to be different vertices of a regular N-sided polygon, and centers of the M (M is an integer of 3 or more) regular N-sided polygons are arranged to be vertices of a regular M-sided polygon.

5. An optical power feeding method using a multicore fiber and a photodiode array to convert light passing through the multicore fiber into electric energy by the photodiode array, wherein
a number of a plurality of cores included in the multicore fiber and a number of a plurality of photodiodes included in the photodiode array are same, and at least the two photodiodes are connected in series.
